(19) United States
(12) Patent Application Publication
(10) Pub. No.: US 2008/0245929 A1
(43) Pub. Date: Oct. 9, 2008

(54) Systems and Methods for Fabricating Multi-Material Joining Mechanisms

(75) Inventors: Jayant D. Patel, Lake Forest, CA (US); Nikhilesh A. Sheth, Cerritos, CA (US)

Correspondence Address: LEE & HAYES, PLLC, 421 W. RIVERSIDE AVE., SUITE 500, SPOKANE, WA, 99201, US

(73) Assignee: THE BOEING COMPANY, Chicago, IL (US)

(21) Appl. No.: 11/861,161

(22) Filed: Sep. 25, 2007

Related U.S. Application Data
(60) Provisional application No. 60/850,093, filed on Oct. 6, 2006.

(51) Int. Cl. B64C 1/06; B05D 3/00

(52) U.S. Cl. 244/131; 427/294

(57) ABSTRACT

Systems and methods for fabricating multi-material joining mechanisms are described. In one embodiment, a tool assembly includes a main body having an outer surface, first and second enclosed ends, and an internal chamber. A plurality of vent holes is disposed through the outer surface, wherein each vent hole fluidly communicates with the internal chamber. A circumferentially-disposed ridge is formed on and extends outwardly from the outer surface proximate the second enclosed end. A port is disposed through the first enclosed end and is configured to be coupled to at least one of a source of pressurized medium and a vacuum. A drive assembly is operatively coupled to the second enclosed end and is configured to rotate the main body during a portion of a fabrication process. During operation, the internal chamber may be evacuated during a cure cycle, or may be pressurized to release a component from the outer surface.

### CROSS REFERENCE TO RELATED APPLICATIONS

This patent application claims priority under 35 U.S.C. §120 from U.S. Provisional Application No. 60/850,093 filed Oct. 6, 2006, which provisional application is incorporated herein by reference.

### FIELD OF THE DISCLOSURE

The field of the present disclosure relates to joining mechanisms for conduits and the like, and more specifically, to methods and systems for fabricating multi-material joining mechanisms, such as those used for joining conduits with other components of environmental control systems in aircraft.

### BACKGROUND

Modern aircraft have environmental control systems that circulate and condition air within a passenger cabin to keep the passengers and crew comfortable. Although such environmental control systems provide considerable advantages, there is room for improvement. For example, during operation, environmental control systems may experience extremely high moisture condensation, particularly in tropical or other high humidity environments.

The connections of the environmental control system may be located above ceiling panels, within side walls and structures, and below floor panels, and may cause a number of undesirable effects. Leakage from connections of the environmental control system may be compounded by several factors, including size differential between connecting components, misalignments between connecting components, deflections of non-rounded components, and gap conditions. Prior art efforts to prevent such conduit leakage have involved mechanical band clamps and adhesive bonding materials, however, such techniques have failed to provide desired levels of reliability, effectiveness, serviceability, and cost. Therefore, novel joining mechanisms that mitigate these conditions, and novel methods and systems for economically fabricating such joining mechanisms, would have utility.

### SUMMARY

The present disclosure is directed toward methods and systems for fabricating multi-material joining mechanisms, such as those used for joining conduits with other components of environmental control systems in aircraft. Embodiments of joining methods and systems in accordance with the present disclosure

In one embodiment, a tool assembly includes a main body having an outer surface, first and second enclosed ends, and an internal chamber. A plurality of vent holes is disposed through the outer surface, each vent hole fluidly communicates with the internal chamber. At least one circumferentially-disposed ridge is formed on and extends outwardly from the outer surface proximate the second enclosed end. At least one port is disposed through the first enclosed end and is configured to be coupled to at least one of a source of pressurized medium and a vacuum. Also, a drive assembly is operatively coupled to the second enclosed end and configured to rotate the main body during a portion of a fabrication process.

In a further embodiment, the main body of the tool assembly described above may further include first and second longitudinally-extending cylindrical sections coupled by a longitudinally-extending transition section. The first cylindrical section has a flared end proximate the first enclosed end, and the second cylindrical section has a bellmouth end proximate the second enclosed end, the at least one ridge being formed on the second cylindrical section.

In another embodiment, a method of fabricating a component includes providing a main body having an outer surface, first and second enclosed ends, and an internal chamber, a plurality of vent holes being disposed through the outer surface in fluid communication with the internal chamber, at least one circumferentially-disposed ridge formed on and extending outwardly from the outer surface proximate the second enclosed end; forming an uncured multi-material matrix on the main body, the multi-material matrix including an inner facing proximate the outer surface, a cellular foam core proximate the inner facing, an outer facing surrounding the foam core, and at least one approximately helical support disposed between the foam core and at least one of the inner and outer facings; providing a vacuum within the internal chamber to draw gases from the multi-material matrix through the plurality of vent holes; simultaneously with providing a vacuum, subjecting the uncured multi-material matrix to a curing cycle including an elevated temperature condition to form a cured multi-material matrix; following the curing cycle, removing the vacuum within the internal chamber; and removing the cured multi-material matrix from the main body.

The features, functions, and advantages that have been described above or will be discussed below can be achieved independently in various embodiments, or may be combined in yet other embodiments, further details of which can be seen with reference to the following description and drawings.

### BRIEF DESCRIPTION OF THE DRAWINGS

Embodiments of methods and systems in accordance with the teachings of the present disclosure are described in detail below with reference to the following drawings.

FIG. 1 is a side cross-sectional view of an interface assembly having a hybrid sleeve fabricated in accordance with an embodiment of the present disclosure;

FIG. 2 is an isometric view of the hybrid sleeve of the interface assembly of FIG. 1;

FIG. 3 is an enlarged side cross-sectional view of the first coupling assembly of the interface assembly of FIG. 1;

FIG. 4 is an end cross-sectional view of the hybrid sleeve of the interface assembly of FIG. 1;

FIG. 5 is an enlarged side cross-sectional view of the second coupling assembly of the interface assembly of FIG. 1;

FIG. 6 is a side cross-sectional view of an interface assembly in accordance with another embodiment of the present disclosure;

FIG. 7 is an enlarged side cross-sectional view of an end portion of a multi-material joining mechanism fabricated using a method or system in accordance with another alternate embodiment of the present disclosure;

FIG. 8 is an isometric view of a tooling assembly for fabricating multi-material joining mechanisms in accordance with another embodiment of the present disclosure;

FIG. 9 is a partially-exploded side cross-sectional view of the tooling assembly of FIG. 8;

FIGS. 10 and 11 are partial side cross-sectional views of the tooling assembly of FIG. 8 during portions of a fabrication process of a multi-material joining mechanism;

FIG. 12 is a flowchart of a method of fabricating a multi-material joining mechanism in accordance with an embodiment of the present disclosure;

FIGS. 13A and 13B present a flowchart of a method of fabricating a multi-material joining mechanism in accordance with an embodiment of the present disclosure; and

FIGS. 14-17 are isometric views of a tooling assembly in accordance with the present disclosure during various portions of the method of fabricating a multi-material joining mechanism of FIGS. 13A and 13B.

### DETAILED DESCRIPTION

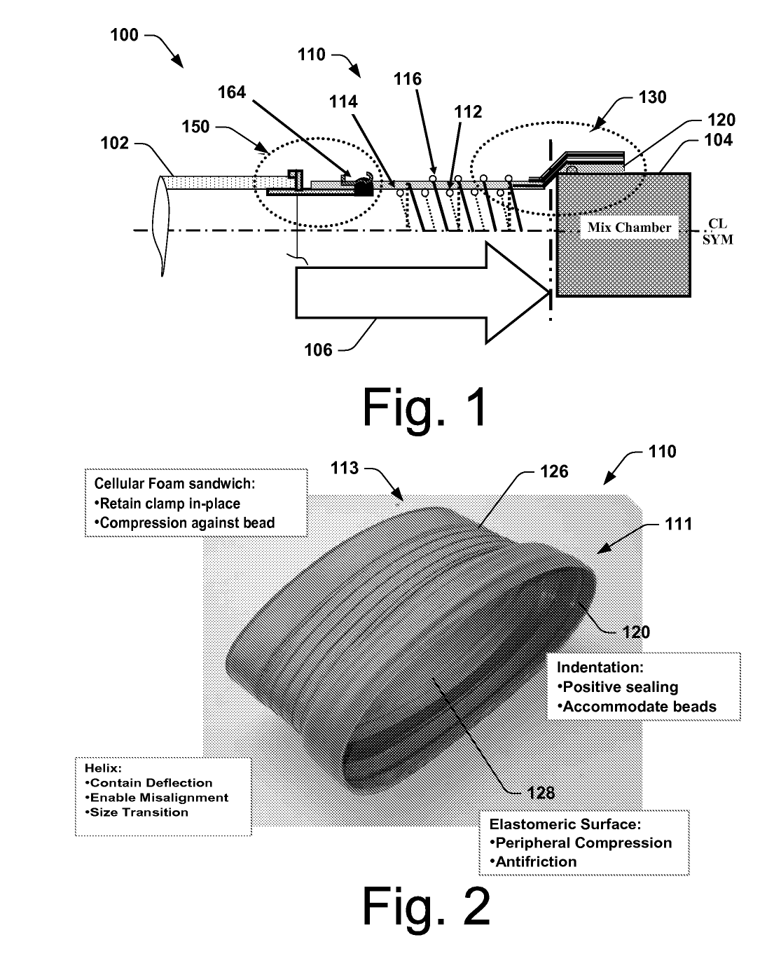

Methods and systems for fabricating multi-material joining mechanisms, such as those used for joining conduits with other components of environmental control systems in aircraft, are described herein. Many specific details of certain embodiments are set forth in the following description and in FIGS. 1-17 to provide a thorough understanding of such embodiments. One skilled in the art will understand, however, that the invention may have additional embodiments, or that alternate embodiments may be practiced without several of the details described in the following description.

In general, embodiments of systems and methods in accordance with the present disclosure effectively address several challenges associated with the manufacture of multi-material joining mechanisms. For example, embodiments in accordance with the present disclosure may advantageously enable mass-production of such components in an efficient, high speed, environmentally friendly, cost-effective, and high quality manner.

### Exemplary Multi-Material Joining Mechanisms

Embodiments of methods and systems for fabricating multi-material joining mechanisms as taught by the present disclosure may be used to fabricate a wide variety of components. In some embodiments, such methods may be used to fabricate multi-material hybrid sleeves of joining mechanisms, such as those that may be used for joining conduits and other components of environmental control systems in modern aircraft.

More specifically, FIG. 1 is a side cross-sectional, partial view of an interface assembly 100 in accordance with an embodiment of the present disclosure. In this embodiment, the interface assembly 100 includes a conduit 102 coupled to a mixing chamber 104 by a hybrid sleeve 11 0. FIG. 2 is an isometric view of the hybrid sleeve 110 of FIG. 1. More specifically, a first end 111 of the hybrid sleeve 110 is coupled to the mix chamber 104 by a first coupling assembly 130, and a second end 113 of the hybrid sleeve 110 is coupled to the conduit 102 by a second coupling assembly 150. In some embodiments, the interface assembly 100 may serve as a portion of an environmental control system that facilitates an airflow 106 to or from a passenger cabin (or other interior region) of an aircraft.

In general, embodiments of helix-reinforced hybrid sleeves of the type shown in FIG. 1 may have a multi-material matrix, and a hybrid edge trim insert to compensate for inconsistent gap conditions with positive sealing. The multi-material matrix may include, in some embodiments, an elastomeric composite, a thermoset composite, an elastomer, and a thermoplastic. Additional aspects of embodiments of helix-reinforced hybrid sleeves of the type shown in FIG. 1 are more fully described, for example, in co-pending, commonly-owned U.S. patent application Ser. No. 11/428,091 entitled “Apparatus, System, and Method for Joining and Sealing Conduits” filed on Jun. 30, 2006, which application is incorporated herein by reference. As described more fully below, hybrid sleeves of the type shown in FIG. 1 may be formed using inventive fabrication systems and methods that involve curing such hybrid sleeves in a single cycle.

With continued reference to FIG. 1, in this embodiment, the hybrid sleeve 110 includes an internal, approximately helical support (or “internal helix”) 112 proximate an inner surface of a foam layer 114, and an external, approximately helical support (or “external helix”) 116 proximate an outer surface of the foam layer 114. In some embodiments, the basic material of the foam layer 114 is a cellular silicone, however, other elastomeric or plastic foam materials can be used. In general, the cellular silicone foam layer 114 may provide low compression-set, good resilience rebound, excellent heat resistance, extreme low temperature properties, and may be highly resistant to oxidation and ozone attack. For aircraft environmental control system applications, the cellular silicone foam layer 114 may advantageously offer the desired performance in terms of meeting operational environment requirements, regulatory flammability requirements, and life cycle requirements.

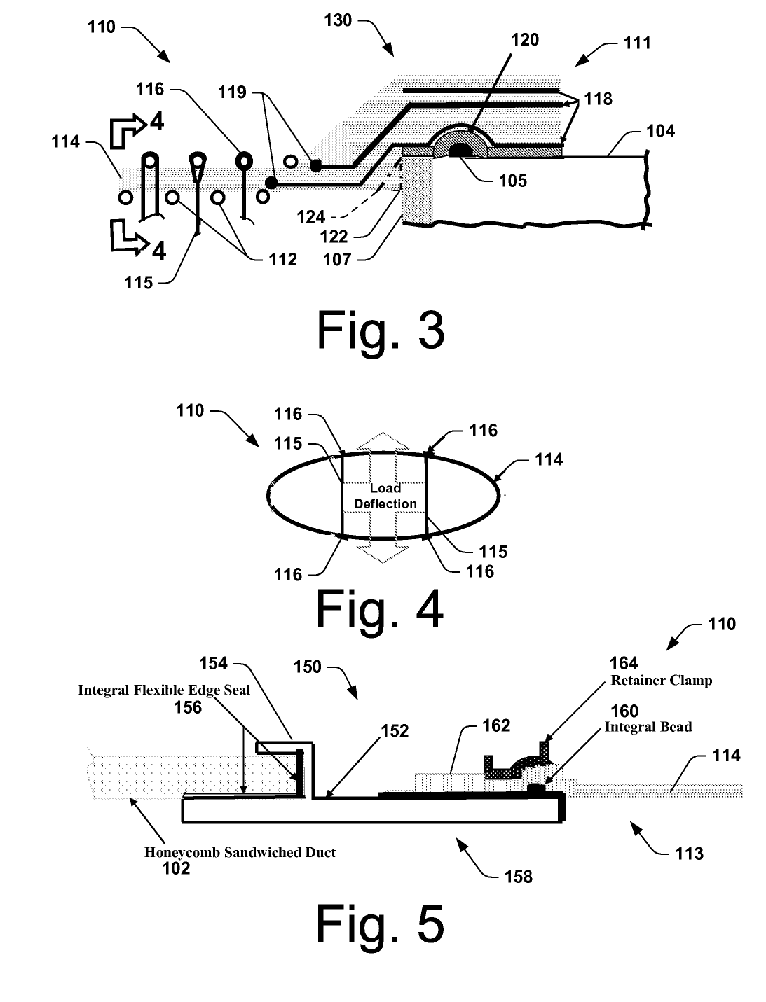

FIG. 3 is an enlarged side cross-sectional view of the first coupling assembly 130 of the interface assembly 100 of FIG. 1. In this embodiment, the foam layer 114 includes a thickened portion having embedded reinforcement layers 118 that provide rigidity to the first end 111 of the hybrid duct 110. The reinforcement layers 118 may, in some embodiments, be thermoplastic impregnated fiberglass composite plies, or uncured epoxy, fiberglass, or other fabric layers. One or more of the reinforcement layers 118 (two are shown in FIG. 3) includes a rounded end (or ball) portion 119, which may be formed of rubber, thermoplastic material, or any other suitable material.

An engagement portion 120 is formed on an inner surface of the foam layer 114 proximate the first end 111, and engages an outer surface of the mix chamber 104. A raised bead 105 is formed on the outer surface of the mix chamber 104. The engagement portion 120 may be formed of a low durometer elastomeric material that provides an improved seal with the raised bead 105 on the mix chamber 104. In some embodiments, a termination (or abutment) 122 is formed (e.g. with same material that is used for reinforcement layers 118 to provide resistance to abrasion and tearing) in the foam layer 114 proximate the engagement portion 120 that engages an end face 107 of the mix chamber 104, providing a physical limit for the engagement of the mix chamber 104 into the first end 111 of the hybrid sleeve 110. In alternate embodiments, the termination 122 is eliminated, and the inner surface of the foam layer 114 assumes a natural transitional shape 124.

FIG. 4 is an end cross-sectional view of the hybrid sleeve 110 of FIG. 3. As shown in this view, a plurality of stringers 115 extend approximately vertically through the hybrid sleeve 110 and have ends that are attached to the external helix 116. The stringers 115 may operate to limit deflections and maintain a specified vertical dimension of the hybrid sleeve 110 when the hybrid sleeve 110 is subjected to an internal pressure load.

It will be appreciated that the first coupling portion 130 may be configured to provide significant advantages over the prior art joining mechanisms. For example, the arrangement of the reinforcement layers 118, and the arrangement of the rounded ends 119, may be configured to achieve a progressive and controlled flexing and functional characteristic of a “living-hinge”. Further, the ply construction counteracts and accommodates stresses created due to misalignments of connecting hardware at the interface location. The reinforcement layers 118 are used to provide rigidity and to enable natural greater pressure (compression) exertion on the engagement portion 120, capturing the raised bead 105 of the mix chamber 104 at the interface for a superior leak-proof seal without deflection.

Each material in the matrix, by virtue of type and termination locations, may meet strategic feature requirements for progressive bending to gradual absorbing misaligned load and preventing lifting and dislodging while providing a positive and uniform pressure for sealing. The reinforcement layers 118 within the matrix are embedded and staggered to control stiffness and provide progressive bending moment around the rounded end (or ball) 119. The rounded end 119 provides a natural hinge and a mechanism for the movement without causing tear of the first coupling assembly 130. The termination 122 provides a natural stop and balances load transmission, and also prevents uprooting sleeve interface due to possible misalignments of the first coupling assembly 130.

In some embodiments, the foam layer 114 may extend the entire length of the hybrid sleeve 110 (e.g. FIGS. 1-2), or alternately, may be formed at the first and second ends 111, 113 proximate the first and second coupling assemblies 130, 150 (proximate conduit 102 and mix chamber 104). The foam layer 114 that extends the length of the hybrid sleeve 110 may provide added thermal and acoustical protection between the gaps and may eliminate the need for secondary means of covering the interface assembly 100 with an insulation blanket. The foam layer 114 at the first and second coupling assemblies 130, 150 provides compression against the mating components for positive seal.

The hybrid sleeve 110 may be configured with pre-determined properties incorporated into its material matrix to provide stiffness, retain shape and prevent the hybrid sleeve 110 from collapsing and choking. The configuration of the hybrid sleeve 110 may also enable smooth bending (e.g. to correct misalignment) without creating air turbulence, may control both low and high frequency noise, and may restrict the hybrid sleeve 110 from ballooning. The diameter, coil pitch, and material type of the internal and external helixes 112, 116 are pre-selected to withstand negative pressure and preventing collapse. The helixes 112, 116 can also be hollow to save weight and provide superior stiffness. The helixes 112, 116 may be fabricated utilizing an unique extrusion and stress relieving process to prevent embrittlement, which is discussed more fully below.

As shown in FIG. 2, in some embodiments, an outer facing 126 is disposed over the outer helix 116 of the hybrid sleeve 110, and an inner facing 128 is disposed over the inner helix 114. The facings 126, 128, also referred to as plies or skins, may be fabricated by deposition of elastomeric coating, impregnating of uncured elastomers (e.g. silicone or other rubber or rubber-based materials) coated on a fiberglass fabric. The several styles of glass fabric can be substituted with other materials or styles, such as an aramid (e.g. Kevlar®), carbon, Nextel®, polyester, or other suitable material, depending upon a customized or intended application. The facings 126, 128 may also provide permeation, tear and wear resistance to the hybrid sleeve 110. Permeation may be an important function in some embodiments because the interface assembly 100 can contain trapped air, and may add resilience and prevent fluid or air leakage while aiding the sealing process.

FIG. 5 is an enlarged side cross-sectional view of the second coupling assembly 150 of the interface assembly 100 of FIG. 1. In this embodiment, the second coupling assembly 150 includes an insert member 152 having a circumferential slot 154 that fittingly receives an end portion of the conduit 102. A flexible seal material 156 is disposed between the conduit 102 and portions of the slot 154 to effectively seal the interface between the conduit 102 and the insert member 152. In some embodiments, the insert member 152 is formed of a composite material, however, in alternate embodiments, any other suitably rigid material may be used.

The insert member 152 further includes a shank portion 158 having an outwardly-extending, integral bead 160 formed thereon. A flexible engagement portion 162 is coupled to the foam layer 114 proximate the second end 113, and is fittingly engaged over the shank portion 158 and integral bead 160 of the insert member 152. A retainer clamp 164 clamps and secures the engagement portion 162 onto the integral bead 160 of the shank portion 158. The retainer clamp 164 is shaped to conform to the integral bead 160 of the shank portion 158.

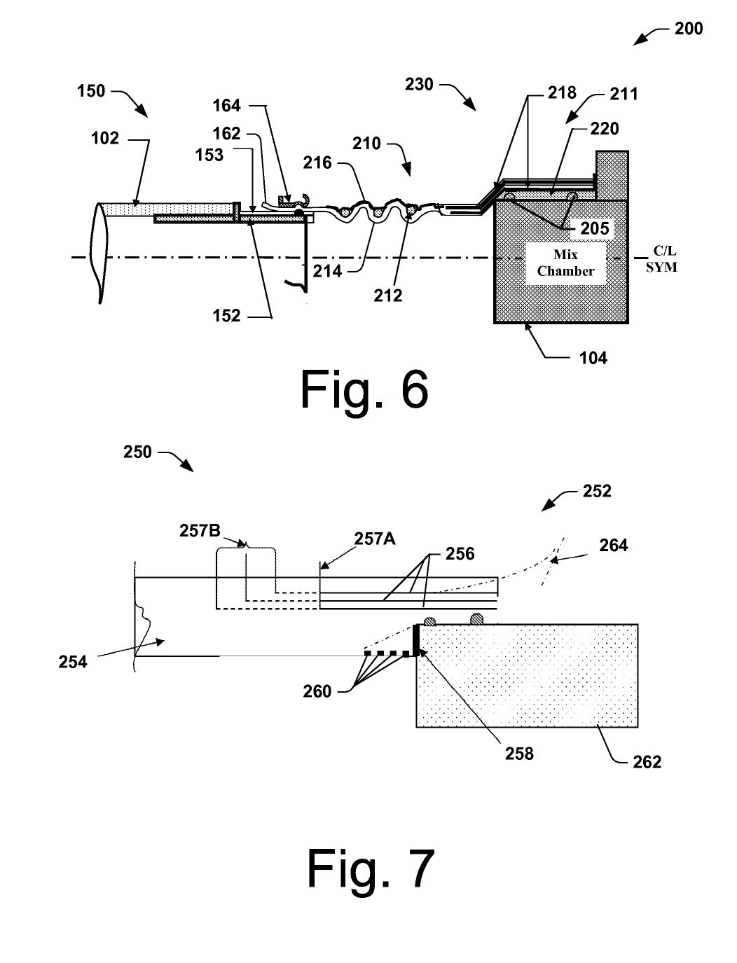

Hybrid sleeves that may be fabricated using the methods and systems disclosed herein are not limited to the particular embodiments described above. For example, FIG. 6 is a side cross-sectional view of an interface assembly 200 in accordance with another embodiment of the present disclosure. Components of the interface assembly 200 that are the same as (or substantially similar to) the corresponding components of the previously described embodiments are referenced using the same reference numerals.

As shown in FIG. 6, the interface assembly 200 includes a hybrid sleeve 210 coupled between the conduit 102 and the mixing chamber 104. In this embodiment, the hybrid sleeve 210 includes a single, approximately helical support (or simply “helix”) 212. In some embodiments, the helix 212 may be formed of a suitable thermoplastic material. The helix 212 is positioned between an inner foam layer 214 and an outer facing 216.

A first coupling assembly 230 couples a first end 211 of the hybrid sleeve 210 to the mix chamber 104. Within the first end 211, the foam layer 214 includes a plurality of reinforcement layers 218, and a compliant engagement portion 220 that engages an outer surface of the mix chamber 104. A pair of annular beads 205 extend outwardly from the mix chamber 104 to provide improved sealing with the engagement portion 220 of the hybrid sleeve 210.

A second coupling assembly 250 is configured similarly to the second coupling assembly 150 described above and shown in FIG. 5. In this embodiment, however, an edge trim 153 is formed on the shank portion 158 of the insert member 152. The edge trim 153 may be a cellular elastomeric silicone that enhances engagement of the shank portion 158 with the engagement portion 162 of the hybrid sleeve 210.

FIG. 7 is an enlarged side cross-sectional view of an end portion 252 of a multi-material joining mechanism (or hybrid sleeve) 250 fabricated using a method or system in accordance with another alternate embodiment of the present disclosure. The end portion 252 includes a foam core layer 254 having several longitudinally-extending, semi-rigid (or substantially rigid) layers 256 formed at various depths therein. In some embodiments, the semi-rigid layers 256 may have ends 257A that are approximately aligned along a single plane. Alternately, the semi-rigid layers 256 may have ends 257B that are staggered (or non-coplanar). A cured silicone (or suction cup feature) 258 may be integrated into the end portion 252 which interfaces with a system component 262. As noted above, the cured silicone 258 may be shaped to abut (or stop) against the system component 262 (e.g. a mix chamber, conduit, etc.). Semi-rigid (or substantially rigid) ribs 260 may be formed within the foam core layer 254 proximate the system component 262, and may extend annularly within the foam core layer 254 to provide additional rigidity of the end portion 252.

In operation, the semi-rigid layers 256 (and for some embodiments, the semi-rigid ribs 260) provide a desired degree of stillness to the end portion 252 during engagement with the system component 262. The stiffness, in turn, serves to maintain a positive seal between the end portion 252 of the multi-material joining mechanism 250 and the system component 262. As shown in FIG. 7, without the stiffening features (layers 256 and ribs 260), the first end 252 would tend to assume an upwardly-turned shape 262 that provides less sealing capability, and which may tend to form openings that cause undesirable leakage.

Embodiments of multi-material joining mechanisms may incorporate several novel aspects, including a uniquely positioned mix of materials to provide needed flexibility, controlled stretch and compression, self-alignment, and oven/autoclave cure integration of material matrices in a single fabrication and cure cycle to provide leak-proof performance. Additional advantages provided by embodiments of the present disclosure include improved operability under adverse conditions such as variable gap, misalignments, defection, size differential and accessibility, while providing a positive sealing mechanism.

### Exemplary Tool Assemblies for Fabricating Multi-Material Joining Mechanisms

Multi-material joining mechanisms, such as those described above and shown in FIGS. 1-7, present considerable manufacturing challenges. Embodiments of systems for fabricating such multi-material joining mechanisms that address these challenges, including the need to mass-produce such components in an efficient, high speed, environmentally friendly, cost-effective, and high quality manner, will now be described.

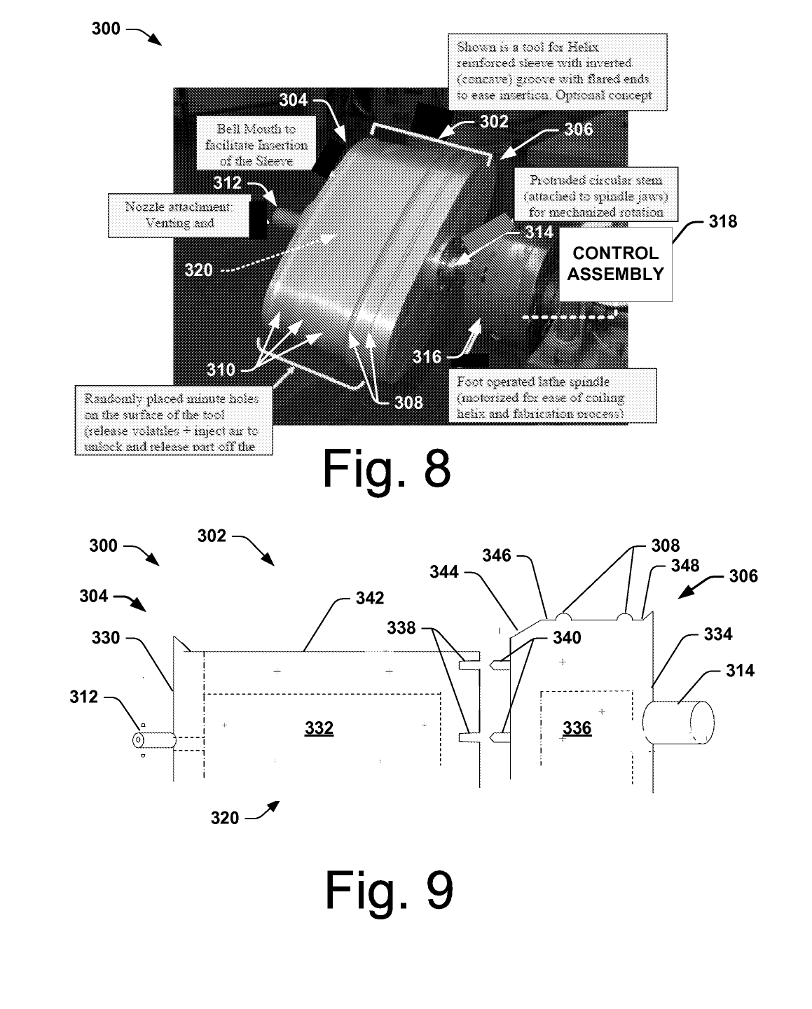

For example, FIG. 8 is an isometric view of a tooling assembly 300 for fabricating hybrid sleeves in accordance with another embodiment of the present disclosure. The tooling assembly 300 includes a main body 302 having an internal chamber 320 (FIG. 9), and also having a flared insertion end 304 and a contoured support end 306. In some embodiments, the main body 302 may be formed using a high strength steel to sustain wear, high temperature, pressure, heat distribution and cooling, which are experienced by the main body 302 during a curing portion of a manufacturing process, as described below. One or more ridges (or beads) 308 are disposed about an outer (or circumferential) surface of the main body 302, and a plurality of vent holes 310 are disposed through and distributed over the outer surface of the main body 302. The vent holes 310 also fluidly communicate with the internal chamber 320 of the main body 302.

Similarly, a port 312 that fluidly communicates with the internal chamber 320 of the main body 302 is disposed in an end surface proximate the insertion end 304. A shaft 314 extends outwardly from another end surface of the main body 302 proximate the support end 306. A motor 316 is operatively coupled to the shaft 314, and a control system 318 is coupled to the motor 316 that enables an operator to controllably rotate the main body 302 during a fabrication process. In a particular embodiment, the motor 316 and control system 318 may comprise a foot-operated drive assembly, such as a foot-operated lathe spindle assembly that enables hands-free operation by the operator. A commercially-available lathe assembly may be customized for this purpose.

FIG. 9 is a partially-exploded side cross-sectional view of the tooling assembly 300 of FIG. 8. In this embodiment, the main body 302 of the tooling assembly 300 includes a primary section 330 defining a first portion 332 of the internal chamber 320, and a secondary section 334 defining a second portion 336 of the internal chamber 320. A plurality of sockets 338 are disposed within an end portion of the primary section 330, and are configured to fittingly receive a corresponding plurality of studs 340 projecting outwardly from the secondary portion 334. In this way, the primary and secondary sections 330, 334 may be selectively interchanged with other sections having other configurations to manufacture a variety of different multi-material joining mechanisms as desired.

The primary and secondary portions 334 may be sized and contoured to meet the particular requirements of a desired multi-material joining mechanism, such as the hybrid sleeve 210 described above and shown in FIG. 6. Specifically, in this embodiment, the primary portion 330 includes the flared insertion end 304, and an approximately cylindrical (non-circular) central section 342. The secondary portion 334 includes a frustrum-shaped transition section 344, an enlarged sealing section 346 that includes the ridges 308, and a bellmouth section 348 proximate the support end 306. As used in this discussion, the term “cylindrical” is intended to refer to both circular and non-circular cylinders. As best shown in FIG. 8, in this embodiment, the main body 302 includes an approximately oval-shaped cylindrical section 342 (and enlarged sealing section 346). In alternate embodiments, the main body 302 may have any desired cross-sectional shape.

As shown in FIG. 10, during a process of fabricating a multi-material joining mechanism (described more fully below), a multi-material layer 350 is formed on the main body 302 of the tool assembly 300. To assist in the removal of the multi-material layer 350 from the main body 302, a pressurized fluid (e.g. air) is provided from source of pressurized fluid 352 through the port 312 and into the internal chamber 320. The pressurized fluid then passes outwardly from the internal chamber 320 through the plurality of vent holes 310 distributed throughout the primary and secondary portions 330, 334 of the main body 302. The pressurized fluid forces the multi-material layer 350 outwardly away from the outer surfaces of the primary and secondary portions 330, 334 of the main body 302, thereby serving to release the layer 350 from the main body 302 for subsequent removal.

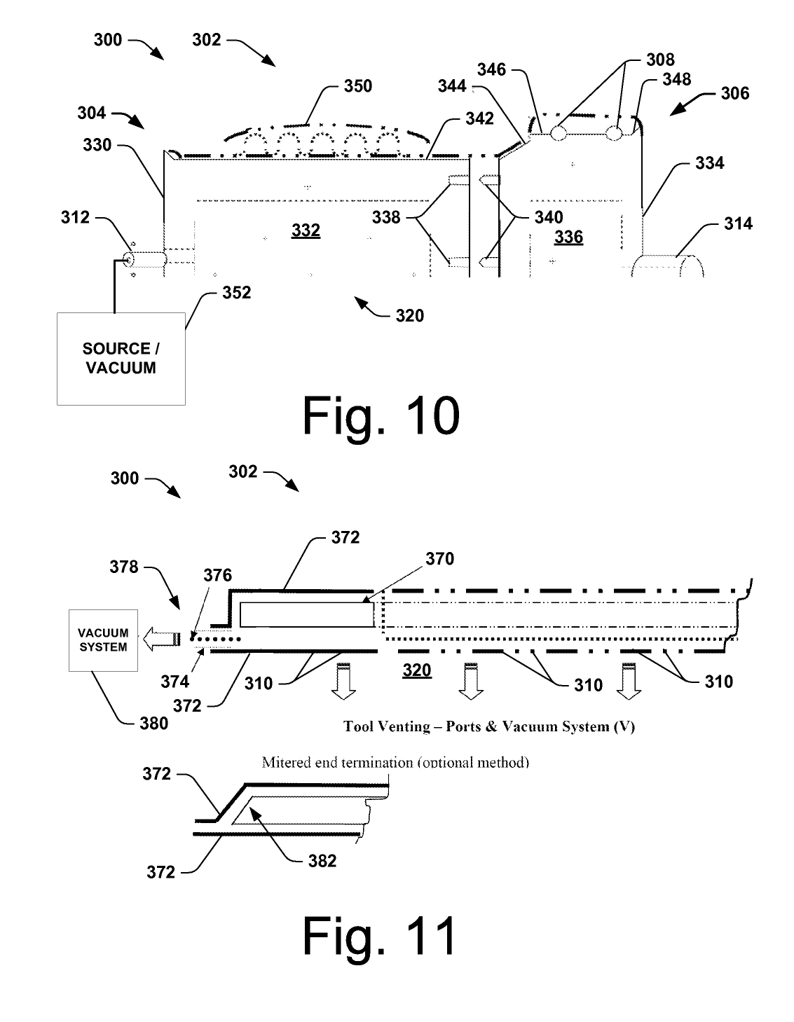

Similarly, FIG. 11 shows the tool assembly 300 during another part of the process of fabricating the multi-material joining mechanism. In this embodiment, a foam core layer 370 is provided between a pair of facings 372, and is disposed on the main body 302. The foam core layer 370 may be situated proximate the ends of the multi-material joining mechanism that is being formed, or alternately, may extend continuously along the length of the multi-material joining mechanism. In a particular embodiment, the facings 372 may be formed of an uncured silicone coated fabric material, however, in alternate embodiments, other suitable materials may be used.

The facings 372 extend beyond an end of the foam core layer 370, and are separated by a breather layer 376 to form an evacuation aperture 378. Release film 374 may be disposed between the breather layer 376 and the facings 372 to prevent vulcanizing and integration of the facings 372 during a heat-cure (oven or autoclave) cycle. A vacuum system 380 may be coupled to the evacuation aperture 378. The vacuum system 380, in combination with the vent holes 310 of the main body 302, may be used to evacuate volatile gases during the fabrication process, allowing proper integration of the facings 372 with the foam core layer 370. After the consolidation process, the release film 374 and the breather layer 376 are removed, and the evacuation aperture (or extension) 378 may be cold bonded and cured with a suitable adhesive, such as a room temperature vulcanize (RTV) adhesive (e.g. RTV 106, RTV 732, or equivalent). Alternately, the facings 372 of the evacuation aperture 378 may be bonded by secondarily heat curing them with a portion of an uncured silicone film.

As shown in FIG. 11, in an alternate embodiment, the foam core layer 370 may be provided with a tapered end 382. For example, in a particular embodiment, the tapered end 382 may be formed by trimming the foam core layer 370, and may form an angle of 45 degrees. Subsequently, an adhesive or adhesive film may be applied onto the tapered end 382 to form a butt splice with another portion (e.g. another portion of foam core layer) or component of the multi-material joining mechanism. Such butt splices may advantageously provide larger barring, constant connection, and continuous sealing, and may adapt to compression, stretch, spread, and movements without parting.

Embodiments of tooling assemblies in accordance with the present disclosure may provide considerable advantages. For example, the internal chamber (or hollow cavity) within the main body facilitates even heat distribution, and enables venting and pressurization. The internal chamber also provides a capacity for controlled cooling and balanced venting. Embodiments of the present disclosure also provide reduced weight for improved handling and reduced wear on supporting equipment. As noted above, gases and volatiles released during a cure cycle may be properly vented to enable integration of material matrix (components) that would otherwise revert.

In addition, embodiments of tooling assemblies in accordance with the present disclosure may also enable the injection of a pressurized medium (e.g. air), encouraging lockable features to unlock from cavities and enable easy release of the multi-material joining mechanism from the tooling assembly to facilitate removal of the part with ease and without binding. The rotatability of such tooling assemblies enables uniform tension and placement of the support helix(es) and other raw materials around the mail body during manufacturing of a multi-material joining mechanism. Overall, embodiments of tooling assemblies in accordance with the present disclosure may be used to accurately and economically fabricate multi-material joining mechanisms.

### Exemplary Methods of Fabricating Multi-Material Joining Mechanisms

Exemplary embodiments of methods of fabricating multi-material joining mechanisms in accordance with the present disclosure will now be described. For simplicity, such embodiments will be described in terms of the exemplary multi-material joining mechanisms and tooling assemblies described above with respect to FIGS. 1-11.

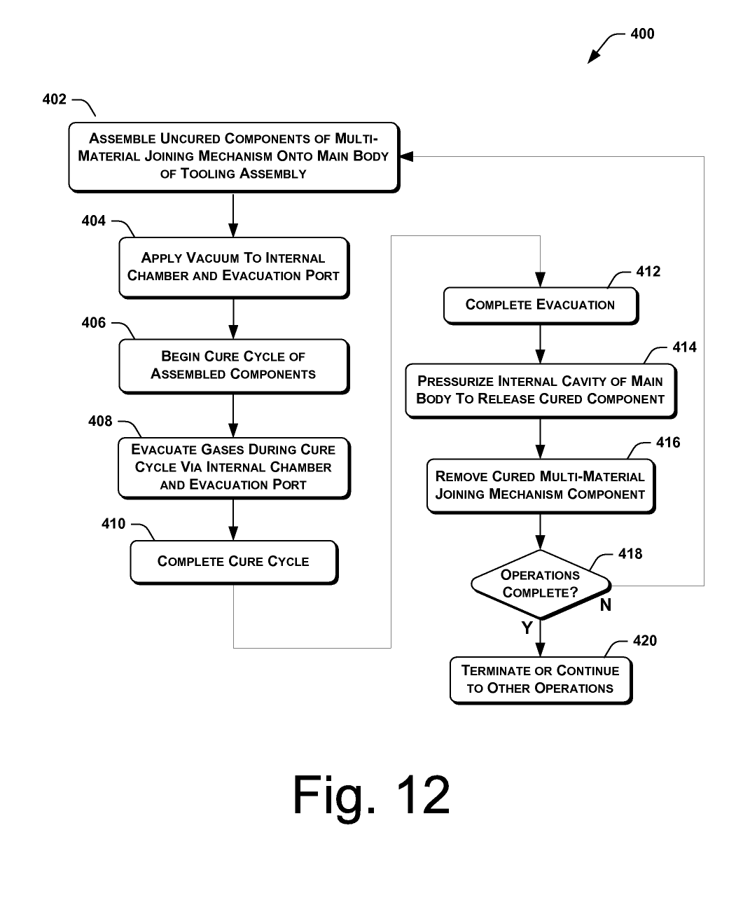

FIG. 12 is a flowchart of a method 400 of fabricating a multi-material joining mechanism in accordance with an embodiment of the present disclosure. It should be appreciated that, in alternate embodiments, certain acts need not be performed in the order described, and may be modified, and/or may be omitted entirely, depending on the circumstances. Moreover, in various embodiments, the acts described may be implemented manually, or by computer, controller, programmable device, robotic device, or any other suitable device.

In this embodiment, the uncured components of a multi-material joining mechanism are assembled onto a main body of a tooling assembly at 402. In various embodiments, the assembling activities at 402 may include assembling one or more foam core layers, and one or more support helixes, between a pair of uncured facings, and also assembling an evacuation port with release films and a breather layer (described above with respect to FIG. 11). During the lay-up of the uncured components, the stiffening layers (and ribs) may be placed within the matrix in the desired end portion(s), as described above with respect to FIG. 7.

The assembling at 402 may include rotating the main body during application of the uncured components onto the main body. In some embodiments, the rotation of the main body may be accomplished by an operator using a hands-free control system. For example, in some embodiments, the tool assembly may be operated using a foot-operated control, similar to an automobile braking system, leaving the operator's hands free to perform fabrication operations.

The assembling at 402 may also include annealing the one or more support helixes to a specific temperature, followed by controlled cooling to relieve residual stresses and prevent embrittlement. In some embodiments, the material that forms the support helix(es) may be placed in an adhesive bath prior to wrap coiling over the foam structure and the final wrapping of the external facing.

As further shown in FIG. 12, at 404, vacuum is applied to the internal chamber of the main body and to the evacuation portion. At 406, a cure cycle of the assembled, uncured components is initiated. The cure cycle may include elevated levels of temperature (e.g. provided by an oven), or elevated levels of both temperature and pressure (e.g. provided by an autoclave). During the cure cycle, volatile gases emitted by the curing components are removed by the vacuum system at 408. At 410, the cure cycle is completed, and at 412, the application of the vacuum is removed.

Next, at 414, the internal cavity of the main body is pressurized to release the cured component from the main body, as described above with respect to FIG. 10. Following the release of the cured component from the main body, the cured multi-material joining mechanism is removed from the main body at 416. At 418, a determination is made whether fabrication operations are complete. If not, then the method 400 returns to the assembling of uncured components at 402, and the actions described above (402 to 418) may be repeated indefinitely. Alternately, if fabrication operations are determined to be complete at 418, then the method 400 terminates or continues to other operations at 420.

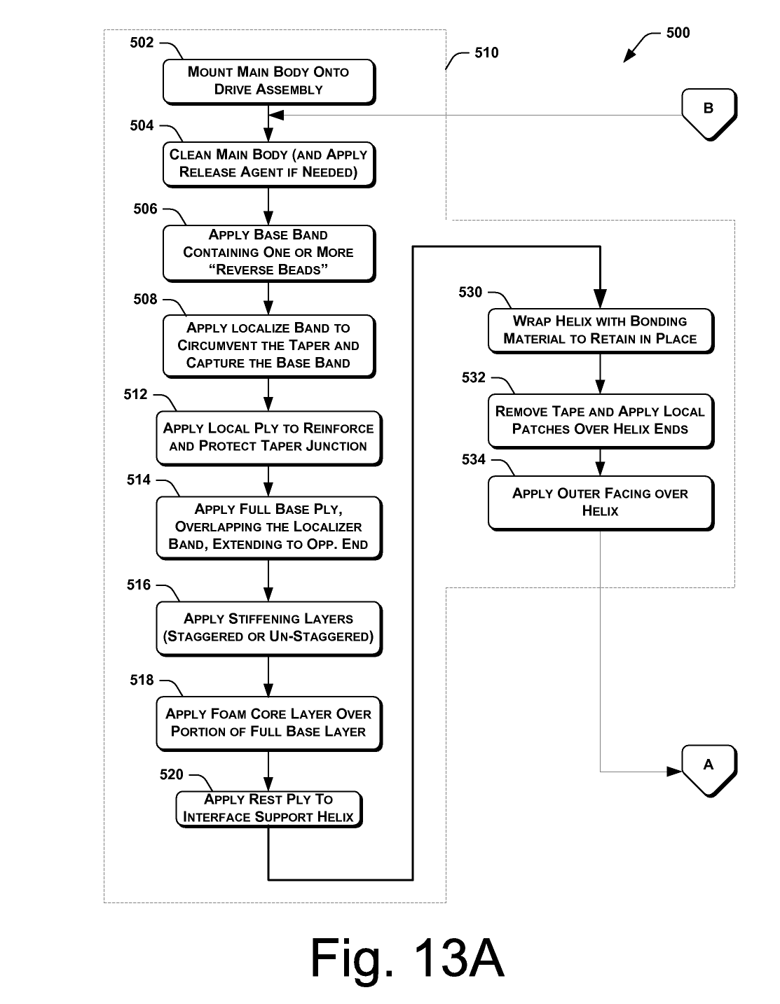

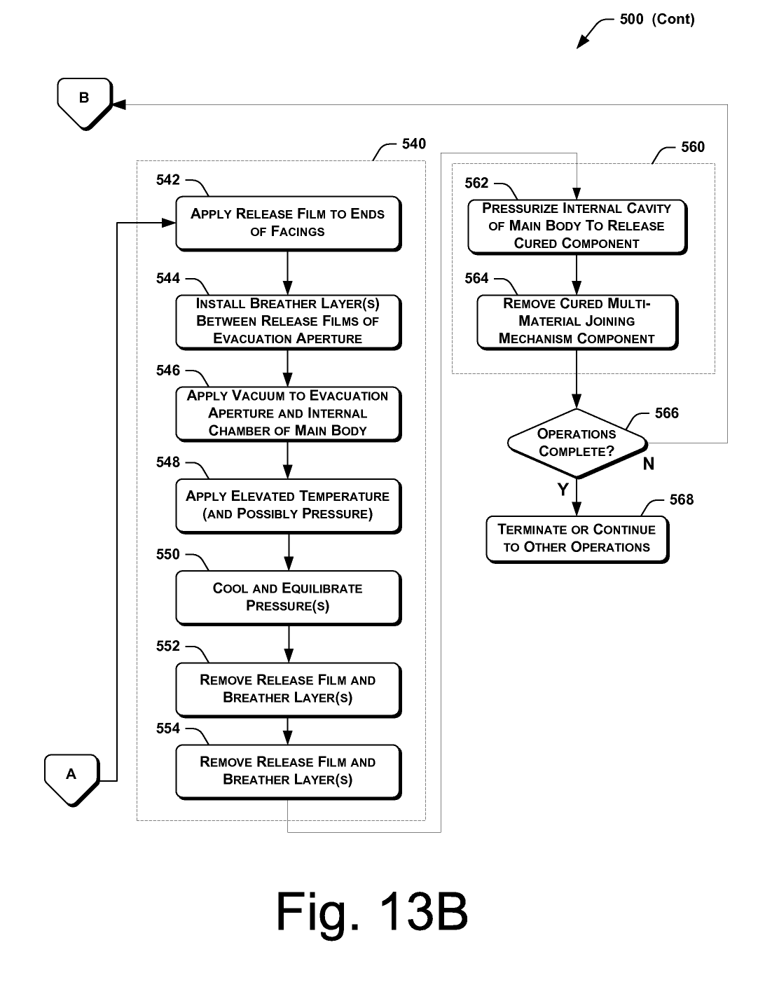

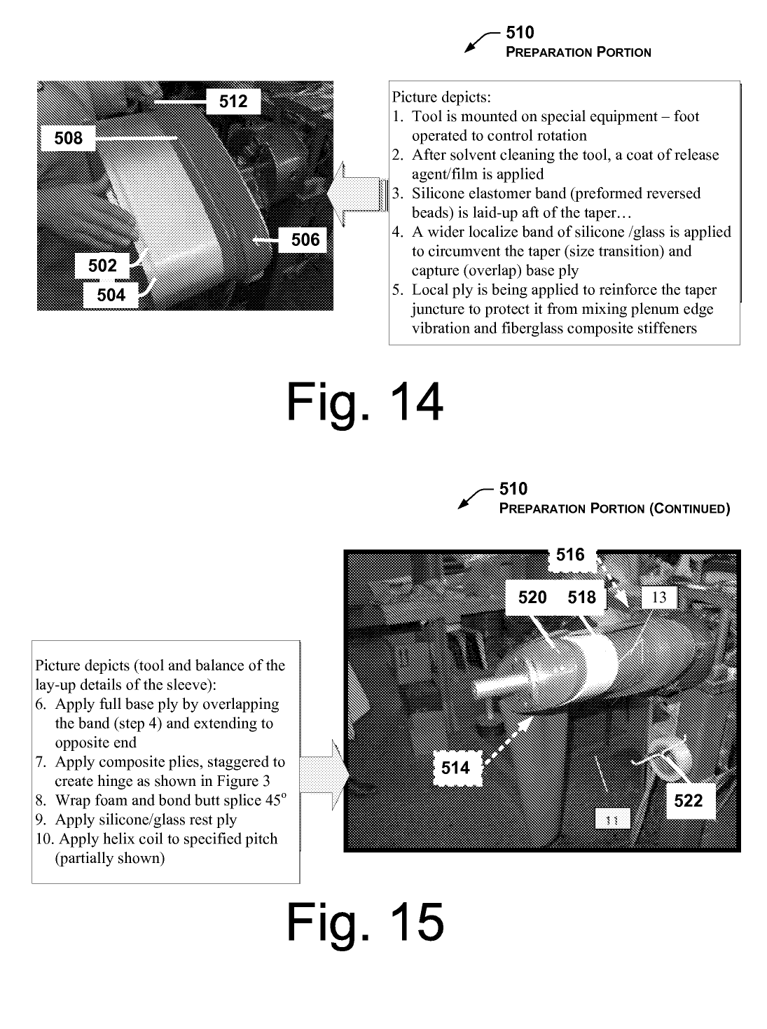

It will be appreciated that a variety of alternate embodiments of fabrication methods may be conceived, and that fabrication methods in accordance with the present disclosure are not limited to the particular embodiment described above and shown in Figure 12. For example, FIGS. 13A and 13B present a flowchart of a method 500 of fabricating a multi-material joining mechanism in accordance with another embodiment of the present disclosure. FIGS. 14-17 are isometric views of various portions of the method 500 of fabricating a multi-material joining mechanism of FIGS. 13A and 13B. Again, it should be appreciated that certain acts need not be performed in the order described, and may be modified, and/or may be omitted entirely, depending on the circumstances.

With reference to FIGS. 13A and 14, in this embodiment, a preparation (or first) phase 510 of the method 500 includes mounting the main body 102 onto a drive assembly at 502 to provide controllable rotation of the main body 102 during subsequent fabrication activities. In a particular embodiment, the main body 102 may be mounted on a shaft 314 that is coupled to a motor 316 driven by a control assembly 318. In further embodiments, the control assembly 318 may be a foot-driven apparatus.

At 504, the surface of the main body 102 is cleaned (e.g. using a solvent or other suitable material), and a release agent may be applied to the cleaned surface. At 506, a base band containing one or more preformed “reversed beads” (or channels) that are configured to mate with corresponding raised beads on another component (e.g. a mix chamber) is laid-up or otherwise provided on the main body 102 aft of (or toward the support end 306) of the tapered section 344 (FIG. 9). In some embodiments, the base band may be formed of a silicone elastomer, however, other suitable materials may also be used. A localizer band is applied at 508 to circumvent the taper and capture (or locate) the base band. The localizer band may be formed of a silicone glass composition, or other suitable material. At 512, a local ply is applied to reinforce a taper juncture and protect the taper juncture from edge vibration of the mating component (e.g. mix chamber) and from the stiffening layers if any are present (FIGS. 3, 6-7).

With continued reference to FIGS. 13A and 15, the preparation portion 510 further includes applying a full base ply at 514, including overlapping the base band (and other previously-applied bands) and extending to an opposite end of the main body 102. At 516, stiffening layers (or composite plys) may be applied in either a staggered or un-staggered configuration (FIG. 7). In some embodiments, the stiffening layers are applied in a staggered configuration to provide a hinge-like assembly, as described above with respect to FIG. 3. At 518, a foam core layer is applied (e.g. wrapped) over a portion of the full base ply. In some embodiments, the application of the foam core layer includes bonding one or more butt splices (FIG. 11). A rest ply may then be applied to serve as an interface with a support helix at 520, and at 522, the support helix is applied (e.g. wound) onto the rest ply at a desired pitch. The main body 102 may be rotated using a drive assembly during the winding of the support helix, as described above with respect to FIG. 8.

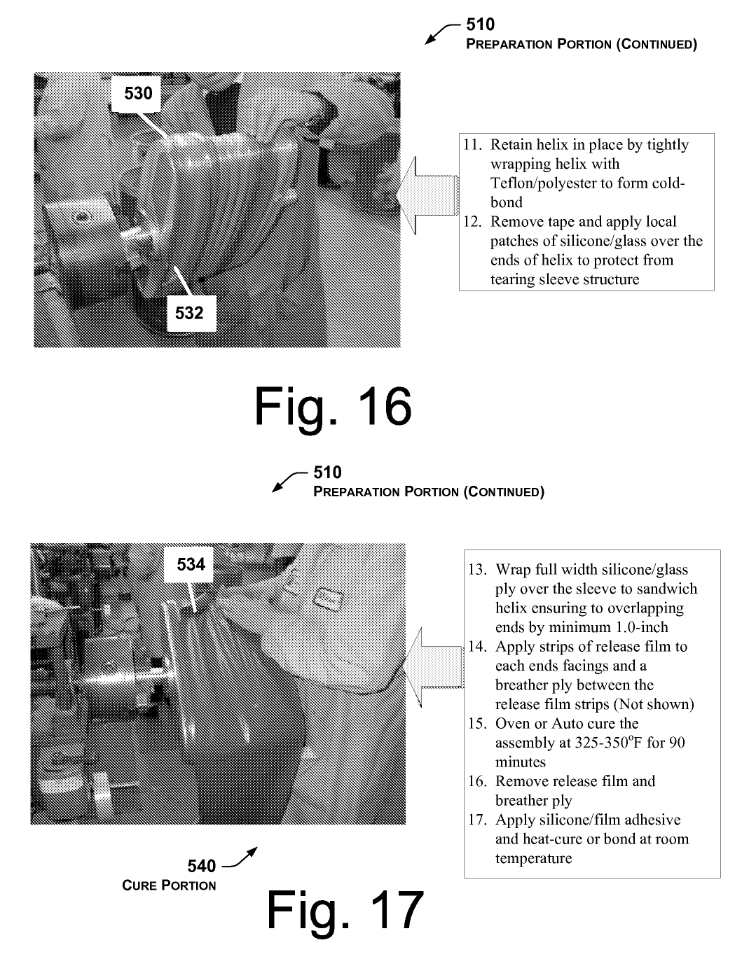

Now referring to FIGS. 13A and 16, the helix is wrapped with a suitable bonding material to retain the helix in place at 530. In some embodiments, the bonding material may be a Teflon®/polyester material configured to consolidate the matrix and form a cold bond with the helix and the underlying rest ply. Similarly, at 532, the tape is removed to expose the helix ends, and local patches are applied under and over the ends of the helix to captivate and protect from tearing other portions or layers of the structure. The local patches may be formed, for example, from a silicone/glass material, and any other suitable compatible material. Finally, at 534 (FIG. 17), a final ply is applied (or wrapped) over the uncured component (e.g. hybrid sleeve). In some embodiments, the final ply may be a full-width silicone/glass ply configured to sandwich the support helix, however, in alternate embodiments, other suitable materials may be used.

The method 500 of fabricating a multi-material joining mechanism continues to a curing phase 540, as shown in FIGS. 13B and 18. In this embodiment, the curing phase 540 includes applying a release film to extending ends of the facings to form an evacuation aperture (FIG. 11). A breather layer is installed between the release films of the evacuation aperture at 544, and at 546, vacuum is applied to the evacuation port and to the internal chamber of the main body 102 to begin consolidating the multi-material matrix and removing gases.

As further shown in FIGS. 13B and 18, at 548, the multi-material matrix structure (and main body 102 of the tooling assembly) may be subjected to elevated temperature, and possibly elevated pressure on the outer facing of the structure. In a particular embodiment, for example, the multi-material matrix structure may be heated (e.g. in an oven or autoclave) at approximately 325 F to 350 F for approximately 90 minutes. In alternate embodiments, other suitable temperatures, pressures, and time periods may be used. After cooling and equilibration of pressures (e.g. removal of the vacuum and/or removal of elevated pressure on outer facing) at 550, the release film and breather ply are removed at 552. Next, the extending portions of the facings that formed the outer layers of the evacuation aperature are bonded at 554. For example, the extending portions may be bonded using a silicone/film adhesive and subsequent heat cure, or alternately, may be bonded at room temperature using any suitable bonding techniques.

Upon completion of the curing phase 540, the method 500 enters a component removal phase 560. As shown in FIG. 13B, at 562, the internal cavity of the main body is pressurized to release the cured component from the main body, as described above with respect to FIG. 10. Following the release of the cured component from the main body, the cured multi-material joining mechanism is removed from the main body at 564. At 566, a determination is made whether fabrication operations are complete. If not, then the method 500 returns to the preparation phase 510, such as the cleaning of the main body at 504 (FIG. 13A), and the above-described actions (504 to 566) may be repeated indefinitely. Alternately, if fabrication operations are determined to be complete at 566, then the method 500 terminates or continues to other operations at 568.

Embodiments of fabrication methods in accordance with the present disclosure may provide significant advantages. For example, such methods may provide a leak-proof assembly that sustains negative pressure, and provides better noise dampening using the support helix. The support helix(es) may be configured with a close pitch (gap between coils) that controls high frequencies, while a wider pitch retards low to mid-level frequencies, thereby eliminating the need of a silencer/muffler upstream, and providing corresponding cost savings.

In addition, embodiments of fabrication methods may substantially reduce fabrication costs in comparison with conventional systems and methods. Such embodiments are damage tolerant, maintenance free, easy to install, and may reduce cycle time by 95%. Also, methods in accordance with the present disclosure may advantageously reduce assembly defect rates from 40% to 0%, and may also reduce in-service warranty reworking costs. Users of joining mechanisms as disclosed herein will experience superior reliable performance, including less maintenance, improved life-cycle, reduced maintenance down time, reduced rework time and expense, and improved passenger comfort.

While specific embodiments of the present disclosure have been illustrated and described herein, as noted above, many changes can be made without departing from the spirit and scope of the invention. Accordingly, the scope of the invention should not be limited by the disclosure of the specific embodiments set forth above. Instead, the scope of various embodiments in accordance with the teachings of the present disclosure should be determined entirely by reference to the claims that follow.

What is claimed is:

1. A tool assembly, comprising:
a main body having an outer surface, first and second enclosed ends, and an internal chamber, a plurality of vent holes being disposed through the outer surface in fluid communication with the internal chamber, at least one circumferentially-disposed ridge formed on and extending outwardly from the outer surface proximate the second enclosed end;
at least one port disposed through the first enclosed end and configured to be coupled to at least one of a source of pressurized medium and a vacuum; and
a drive assembly operatively coupled to the second enclosed end and configured to rotate the main body during a portion of a fabrication process.

2. The tool assembly of claim 1, wherein the main body further includes:
first and second longitudinally-extending cylindrical sections coupled by a longitudinally-extending transition section, the first cylindrical section having a flared end proximate the first enclosed end and the second cylindrical section having a bellmouth end proximate the second enclosed end, the at least one ridge being formed on the second cylindrical section.

3. The tool assembly of claim 2, wherein the main body further includes a primary portion removeably coupled to a secondary portion, the primary portion including the first longitudinally-extending cylindrical section, and the secondary portion including the second longitudinally-extending cylindrical section and the longitudinally-extending transition section.

4. The tool assembly of claim 3, wherein at least one of the primary portion and the secondary portion includes a plurality of longitudinally-extending studs, and the other of the primary and secondary portions includes a corresponding plurality of longitudinally-extending sockets configured to fittingly receive the plurality of longitudinally-extending studs.

5. The tool assembly of claim 2, wherein the at least one circumferentially-disposed ridge includes a first circumferentially-disposed ridge disposed on the second longitudinally-extending cylindrical section proximate the longitudinally-extending transition section, and a second circumferentially-disposed ridge disposed on the second longitudinally-extending cylindrical section proximate the bellmouth end.

6. The tool assembly of claim 1, wherein the drive assembly further includes a control system operatively coupled to the motor and configured to enable controllable rotation of the main body.

7. The tool assembly of claim 6, wherein the control system comprises a foot-operated control system.

8. A method of fabricating a component, comprising:
providing a main body having an outer surface, first and second enclosed ends, and an internal chamber, a plurality of vent holes being disposed through the outer surface in fluid communication with the internal chamber, at least one circumferentially-disposed ridge formed on and extending outwardly from the outer surface proximate the second enclosed end;
forming an uncured multi-material matrix on the main body, the multi-material matrix including an inner facing proximate the outer surface, a foam core proximate the inner facing, an outer facing surrounding the foam core, and at least one approximately helical support disposed between the foam core and at least one of the inner and outer facings;
providing a vacuum within the internal chamber to draw gases from the multi-material matrix through the plurality of vent holes;
simultaneously with providing a vacuum, subjecting the uncured multi-material matrix to a curing cycle including an elevated temperature condition to form a cured multi-material matrix;
following the curing cycle, removing the vacuum within the internal chamber; and
removing the cured multi-material matrix from the main body.

9. The method of claim 8, wherein forming an uncured multi-material matrix further includes forming a plurality of longitudinally-extending stiffening layers formed at various depths within the foam core proximate the second enclosed end.

10. The method of claim 9, wherein forming a plurality of longitudinally-extending stiffening layers includes forming a plurality longitudinally-extending stiffening layers in a longitudinally-staggered configuration to provide an approximately hinge-like portion.

11. The method of claim 8, wherein forming an uncured multi-material matrix further includes forming a first approximately helical support disposed between the foam core and the inner facing, and forming a second approximately helical support disposed between the foam core and the outer facing.

12. The method of claim 8, further comprising, following the curing cycle, pressurizing the internal chamber to force a pressurized medium through the plurality of vent holes to release the cured multi-material matrix from the outer surface.

13. The method of claim 8, wherein forming an uncured multi-material matrix on the main body includes providing an extension end of each of the inner and outer facings that extends beyond an end portion of the foam layer, the method further comprising:
providing a breather layer between the extension ends of the inner and outer facings to form an evacuation aperture; and
applying a vacuum through the evacuation aperture simultaneously with the providing a vacuum within the internal chamber.

14. The method of claim 13, further comprising providing a release film between the breather layer and the extension ends to prevent bonding of the breather layer and the extension ends during the curing cycle.

15. The method of claim 8, wherein forming an uncured multi-material matrix on the main body includes:
rotating the main body; and
simultaneously with rotating the main body, winding the at least one approximately helical support onto the main body.

16. The method of claim 15, wherein rotating the main body includes controllably rotating the main body by actuating a foot-operated control assembly.

17. The method of claim 8, wherein forming an uncured multi-material matrix on the main body further includes applying a base band having at least one circumferentially-disposed channel formed therein onto the main body, the at least one circumferentially-disposed channel receiving the at least one circumferentially-disposed ridge of the main body.

18. The method of claim 8, wherein forming an uncured multi-material matrix on the main body further includes forming a first portion of the foam core on the inner facing proximate the first enclosed end, and forming a second portion of the foam core on the inner facing proximate the second enclosed end.

19. The method of claim 18, wherein forming an uncured multi-material matrix on the main body further includes forming the foam core over approximately an entire length of the main body.

20. The method of claim 18, wherein forming the first and second portions of the foam core includes joining at least one butt splice at a tapered end portion of at least one of the first and second portions of the foam core.
